(19) United States
(12) Patent Application Publication
(10) Pub. No.: US 2012/0254306 A1
(43) Pub. Date: Oct. 4, 2012

(54) SCREEN SHARING METHOD, SCREEN SHARING APPARATUS, AND NON-TRANSITORY, COMPUTER READABLE STORAGE MEDIUM

(75) Inventor: Kazuki MATSUI, Kawasaki (JP)

(73) Assignee: Fujitsu Limited, Kawasaki (JP)

(21) Appl. No.: 13/362,369

(22) Filed: Jan. 31, 2012

(30) Foreign Application Priority Data
Mar. 28, 2011 (JP) 2011-071171

(51) Int. Cl. G06F 15/16

(52) U.S. Cl. 709/204

(57) ABSTRACT

A method of sharing a screen, performed by a computer, has drawing on a screen an image on predetermined information stored in an information storage unit and recording, in a range storage unit, range information indicating a range of the image on the screen, replacing the range indicated by the range information stored in the range storage unit with a predetermined image in the image on the screen to be transferred to a sharing destination of the screen, and transferring the image on the screen having the range replaced with the predetermined image to an apparatus of the sharing destination of the screen.

### CROSS-REFERENCE TO RELATED APPLICATION

This application is based upon and claims the benefit of priority of the prior Japanese Patent Application No. 2011-071171, filed on Mar. 28, 2011, the entire contents of which are incorporated herein by reference.

### FIELD

The embodiment discussed herein is related to a screen sharing method, a screen sharing apparatus, and a program.

### BACKGROUND

Mobile phones have become highly functional, and thus operation procedures of the mobile phones are becoming complicated. As a result, it often happens that unaccustomed users do not know how to operate the mobile phones, and make mistakes in operating the mobile phones. There are also cases where malfunction of a mobile phone itself makes it difficult for a user to perform normal operation of the mobile phone.

If a user encounters inconveniences on operation of a mobile phone as described above, the user asks a dealer shop or a help desk in order to get information. The user explains his or her situation to an operator on the help desk through a telephone, etc. The operator is not allowed to directly operate the mobile phone, and thus it is important for the operator by himself or herself to correctly grasp the situation in order to shorten time needed until the problem is solved.

Accordingly, for example, in the case of a PC, etc., a remote-operation support system has been implemented using a remote desktop facility or a screen sharing technique. Using the remote desktop facility, etc., an operator terminal is allowed to share a screen of a user PC through the Internet, and thus the operator is allowed to operate a user's PC remotely. As a result, it is possible to improve work efficiency compared with supporting simply through a telephone.

A related-art technique has been disclosed in Japanese Laid-open Patent Publication No. 2007-156669, for example.

### SUMMARY

According to an aspect of the embodiment, a method of sharing a screen, performed by a computer, has drawing on a screen an image on predetermined information stored in an information storage unit and recording, in a range storage unit, range information indicating a range of the image on the screen, replacing the range indicated by the range information stored in the range storage unit with a predetermined image in the image on the screen to be transferred to a sharing destination of the screen, and transferring the image on the screen having the range replaced with the predetermined image to an apparatus of the sharing destination of the screen.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a screen sharing system according to the present embodiment.

FIG. 2 is a diagram illustrating an example of a hardware configuration of a user terminal according to the present embodiment.

FIG. 3 is a diagram illustrating an example of a functional configuration of the screen sharing system according to the present embodiment.

FIGS. 4A and 4B are diagrams for explaining a screen sharing mechanism according to the present embodiment.

FIG. 5 is a flowchart for explaining an example of a processing procedure at the time of displaying protected data.

FIG. 6 is a diagram illustrating a display example of a menu screen.

FIG. 7 is a diagram illustrating a display example of a password-input screen.

FIG. 8 is a diagram illustrating a display example of an address book screen on a user terminal.

FIG. 9 is a diagram illustrating a display example of an address book screen on an operator terminal.

FIG. 10 is a flowchart for explaining an example of a processing procedure of drawing processing.

FIG. 11 is a diagram for explaining an example of a drawing range.

FIG. 12 is a diagram illustrating an example of a configuration of a drawing-range storage unit.

FIG. 13 is a flowchart for explaining an example of a processing procedure of extraction and mask processing of a difference image.

FIG. 14 is a diagram illustrating an example of an extracted difference image.

FIG. 15 is a diagram for explaining an example of replacing a difference image with an alternative image.

### DESCRIPTION OF EMBODIMENT

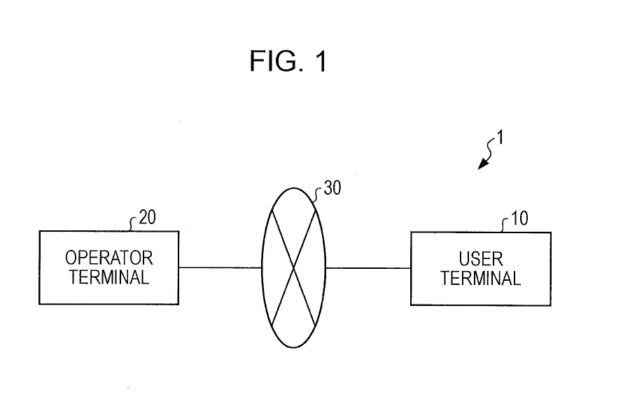

In the following, a description will be given of the present embodiment on the basis of the drawings. FIG. 1 is a diagram illustrating an example of a configuration of a screen sharing system according to the present embodiment. In FIG. 1, a screen sharing system 1 includes one or more user terminals 10 and one or more operator terminals 20, etc. The user terminal 10 and the operator terminal 20 are connected in a communicable manner through a network 30 (regardless of wired or wireless), for example, the Internet or a mobile communication network, etc.

In the present embodiment, the user terminal 10 corresponds to a screen sharing source (or a screen sharing server), and the operator terminal 20 corresponds to a screen sharing destination (or a screen sharing client). That is to say, in the present embodiment, it is assumed that a screen on the user terminal 10 is shared with the operator terminal 20 using a technique called a remote desktop or screen sharing. That is to say, this case corresponds to the case where a user of the user terminal 10 is remotely supported by an operator of the operator terminal 20. However, a technique according to the present embodiment may be applied to the other application other than the case of receiving support by an operator. In this regard, the user terminal 10 may be a mobile information processing apparatus, such as a mobile phone or a smart phone, etc. Alternatively, the user terminal 10 may be a non-mobile information processing apparatus, such as a desktop PC (Personal Computer), etc. Also, in the present embodiment, a “screen” means an image displayed on a display unit.

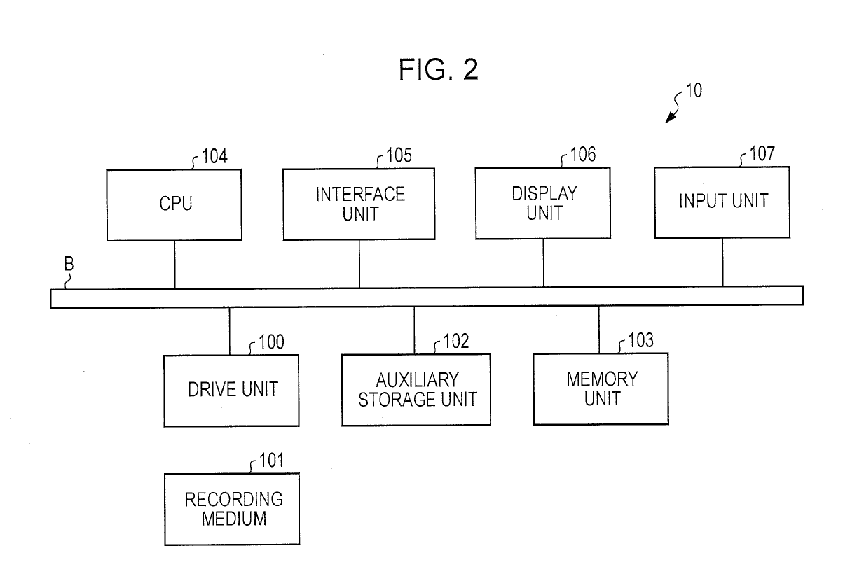

FIG. 2 is a diagram illustrating an example of a hardware configuration of a user terminal according to the present embodiment. The user terminal 10 in FIG. 2 has a drive unit 100, an auxiliary storage unit 102, a memory unit 103, a CPU 104, an interface unit 105, a display unit 106, an input unit 107, etc., which are mutually connected through a bus B.

The program performing processing on the user terminal 10 is provided by a recording medium 101. When the recording medium 101 recording the program is set in the drive unit 100, the program is installed from the recording medium 101 to the auxiliary storage unit 102 through the drive unit 100. However, the installation of the program does not need to be carried out from the recording medium 101, and may be downloaded from another computer through a network. The auxiliary storage unit 102 stores the installed program, files, data, etc., that are needed.

When a program start instruction is given, the memory unit 103 reads the program from the auxiliary storage unit 102 to store the program. The CPU 104 performs functions related to the user terminal 10 in accordance with the program stored in the memory unit 103. The interface unit 105 is used as an interface for connecting to a network (regardless of wired or wireless). The display unit 106 displays a GUI (Graphical User Interface), etc., by a program. The input unit 107 is a keyboard and a mouse, or a button, or a touch panel, etc., and is used for inputting various operation instructions.

In this regard, as an example of the recording medium 101, a portable recording medium, such as a CD-ROM, a DVD disc, or a USB memory, etc., are given. Also, as an example of the auxiliary storage unit 102, an HDD (Hard Disk Drive) or a flash memory, etc., are given. Both the recording medium 101 and the auxiliary storage unit 102 correspond to computer-readable recording media.

In this regard, the operator terminal 20 has, for example, the same hardware as that illustrated in FIG. 2.

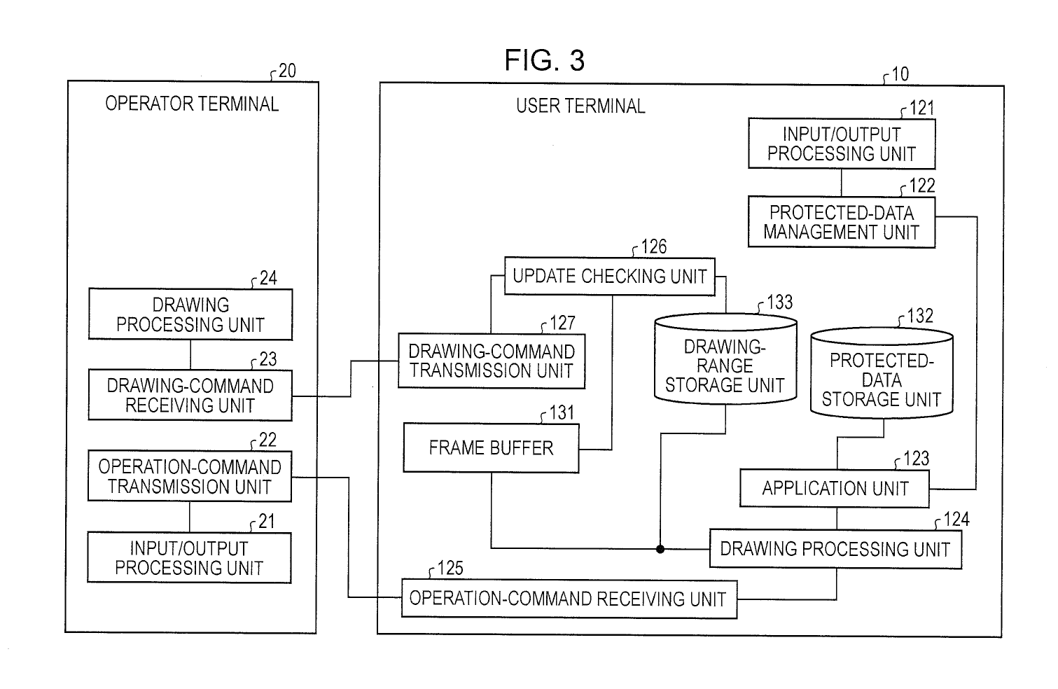

FIG. 3 is a diagram illustrating an example of a functional configuration of the screen sharing system according to the present embodiment. In FIG. 3, the user terminal 10 has an input/output processing unit 121, a protected-data management unit 122, an application unit 123, a drawing processing unit 124, an operation-command receiving unit 125, an update checking unit 126, and a drawing-command transmission unit 127, etc. The processing of each of these units is achieved by the CPU 104 executing the program installed in the user terminal 10. The user terminal 10 also has a frame buffer 131, a protected-data storage unit 132, a drawing-range storage unit 133, etc. The frame buffer 131 and the protected-data storage unit 132, etc., can be achieved using a volatile memory, such as the memory unit 103, for example. The protected-data storage unit 132 can be achieved using a nonvolatile storage unit, such as the auxiliary storage unit 102, for example,.

The input/output processing unit 121 performs processing control in accordance with an operation instruction through the input unit 107, performs display control onto the display unit 106, etc. The protected-data management unit 122 performs processing for protecting the protected data when an operation instruction on protected data (an access instruction to protected data) is inputted. In the present embodiment, the protected data means, for example, data including information on privacy of a user of the user terminal 10. Specifically, data having different contents depending on a user, such as data including information by user's operations, data including a user's operation history, etc., can be the protected data. As an example of input information by user's operation, for example, contents of emails, an image captured by a digital camera not illustrated in the figures (hereinafter referred to as a “captured image”), an address book, bookmarks on Web sites, the other document information, etc., are given. Also, as an example of a user operation history, an incoming call list, an outgoing call list, an access history to Web sites, etc., are given.

The processing for protecting protected data includes, for example, a request for inputting a password, and authentication of the input password, etc.

The application unit 123 provides a display function or an edit function of the protected data, etc., in response to an instruction from the user. For example, the application unit 123 performs display or edit, etc., of an email, a captured image, an address book, bookmarks, an incoming call list, an outgoing call list, or the other document information. The protected-data storage unit 132 stores various kinds of protected data that are operated (displayed or edited, etc.) by the application unit 123.

The operation-command receiving unit 125 receives an operation command transmitted by the operator terminal 20 that is sharing a screen of the user terminal 10. The operation command means data indicating an operation instruction to the screen of the user terminal 10, which has been input by the operator terminal 20.

The drawing processing unit 124 performs drawing (writing) on screen data stored in the frame buffer 131 in response to a drawing request from the application unit 123 or an operation command received by the operation-command receiving unit 125. The screen data means image data indicating display contents of a screen displayed on the display unit 106 of the user terminal 10. With respect to an image drawn on protected data, the drawing processing unit 124 records information indicating a drawing range of the image on a screen in the drawing-range storage unit 133.

The update checking unit 126 checks the frame buffer 131 on a certain cycle, and extracts an image of the difference between screen data in the frame buffer 131 at previous checking time, and screen data in the frame buffer 131 at this time (hereinafter referred to as a “difference image”). In the screen data at this time, the update checking unit 126 replaces protected data in a drawing range of the difference image with a predetermined image. That is to say, masking is applied to the drawing range. The drawing range of the protected data is identified by referring to the drawing-range storage unit 133. In this regard, the update checking unit 126 saves the screen data of the frame buffer 131 at previous checking time in order to extract the difference image.

The drawing-command transmission unit 127 transmits data indicating a drawing instruction of the difference image extracted by the update checking unit 126 (hereinafter referred to as a “drawing command”) to the operator terminal 20.

On the other hand, the operator terminal 20 has an input/output processing unit 21, an operation-command transmission unit 22, a drawing-command receiving unit 23, and a drawing processing unit 24, etc.

The input/output processing unit 21 performs processing control in accordance with an operation instruction input through the input unit of the operator terminal 20, performs display control of the display unit, etc. The operation-command transmission unit 22 transmits an operation command of an operation instruction on a screen of the user terminal 10 (hereinafter referred to as a “shared screen”), which is shared by the operator terminal 20, to the user terminal 10. The drawing-command receiving unit 23 receives the drawing command transmitted from the user terminal 10. The drawing processing unit 24 performs drawing processing in accordance with the drawing command received by the drawing-command receiving unit 23.

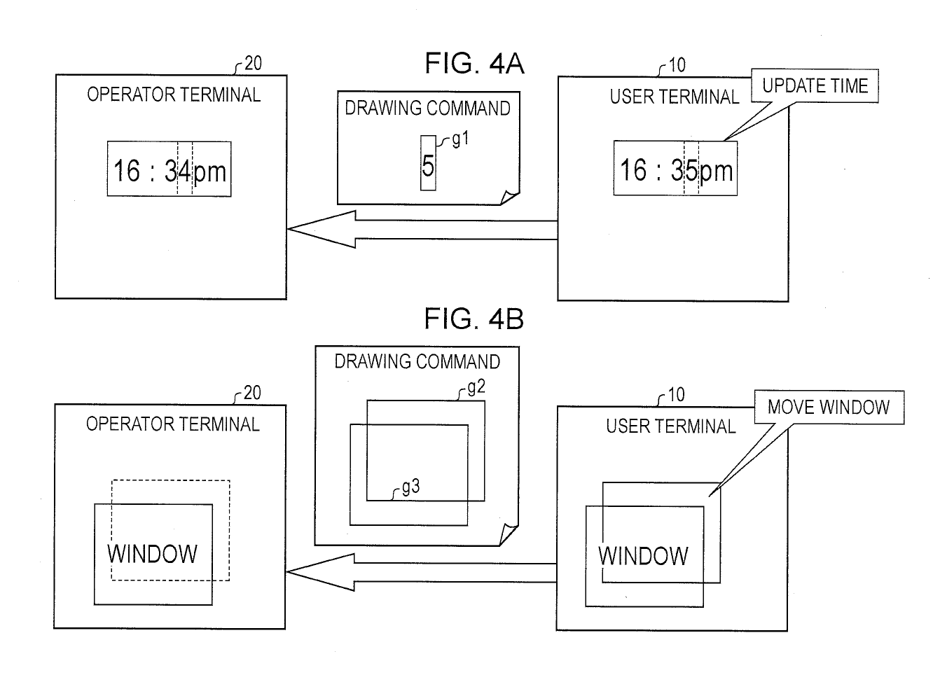

Next, a description will be given of a screen sharing mechanism according to the present embodiment. FIG. 4A and FIG. 4B are diagrams for explaining a screen sharing mechanism according to the present embodiment.

FIG. 4A illustrates an example in which time displayed on a screen of the user terminal 10 is updated. In this case, the drawing processing unit 124 draws an image indicating a character string of “16:35 pm” into the frame buffer 131 in accordance with passage of time. The update checking unit 126 extracts an image of a rectangular area including the difference between “4” and “5” as a difference image g1 by monitoring the frame buffer 131 periodically. The drawing-command transmission unit 127 transmits a drawing command indicating a drawing instruction of the difference image g1 to the operator terminal 20. The drawing command is received by the drawing-command receiving unit 23 of the operator terminal 20. The drawing processing unit 24 of the operator terminal 20 updates display contents on the shared screen in accordance with the drawing command. As a result, the display contents on the screen of the operator terminal 20 matches the display contents on the screen of the user terminal 10.

FIG. 4B illustrates the case where a move instruction of a window on a shared screen is inputted on the operator terminal 20. In this case, the input/output processing unit 21 of the operator terminal 20 detects the move instruction, and notifies the contents of the move instruction to the operation-command transmission unit 22. The operation-command transmission unit 22 transmits the operation command indicating the contents of the move instruction to the user terminal 10. The operation command is received by the operation-command receiving unit 125 of the user terminal 10. The drawing processing unit 124 of the user terminal 10 draws an image expressing a window after the movement in accordance with the operation command into the frame buffer 131. The update checking unit 126 extracts the image of an area including the difference of the screen data caused by the movement of the window as a difference image g2 and a difference image g3 by monitoring the frame buffer 131 periodically. In this regard, FIG. 4B illustrates an example in which the window contents are uniform. If the window contents are not uniform, for example, in place of the difference image g3, the entire window after the movement is extracted as the difference image. The drawing-command transmission unit 127 transmits a drawing command indicating a drawing instruction of the difference images g2 and g3 to the operator terminal 20. The drawing command is received by the drawing-command receiving unit 23 of the operator terminal 20. The drawing processing unit 24 of the operator terminal 20 updates the display contents on the shared screen in accordance with the drawing command. As a result, the display contents of the screen of the operator terminal 20 matches the display contents of the screen of the user terminal 10.

In this manner, the user terminal 10 transfers the difference image to the operator terminal 20 so that the display contents of a shared screen on the operator terminal 20 matches the screen contents of the user terminal 10.

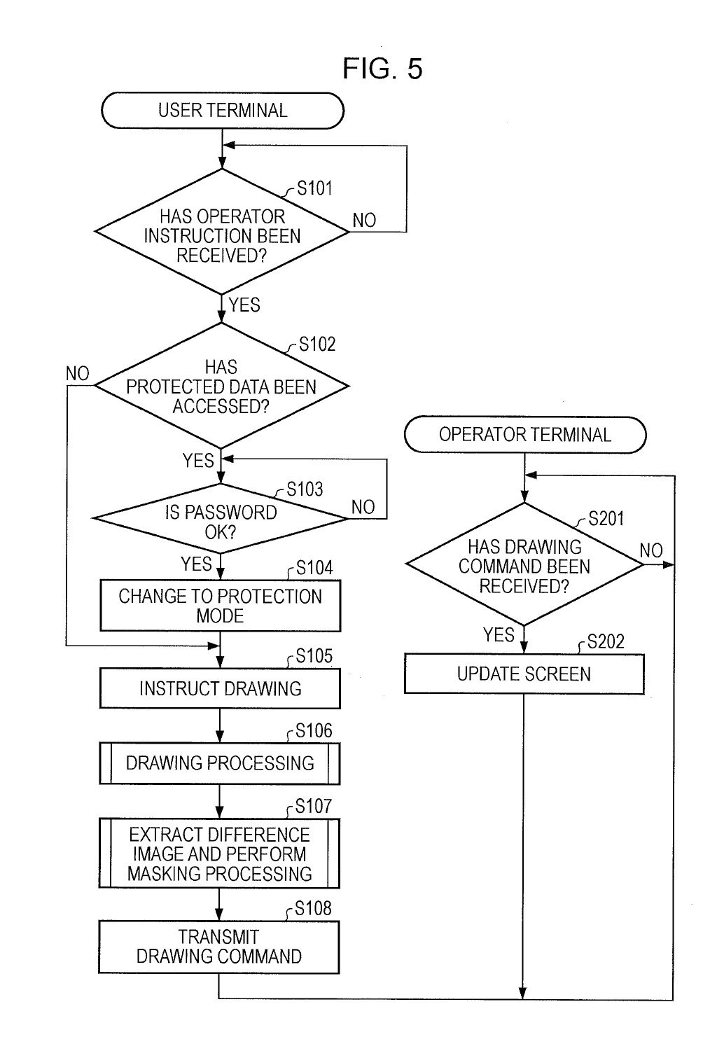

In the following, a description will be given of a processing procedure of the screen sharing system 1. FIG. 5 is a flowchart for explaining an example of a processing procedure at the time of displaying protected data.

For example, in a state in which a menu screen is displayed on the user terminal 10, when an operation instruction is inputted through the input unit 107, the operation instruction is detected by the input/output processing unit 121 (Yes in S101).

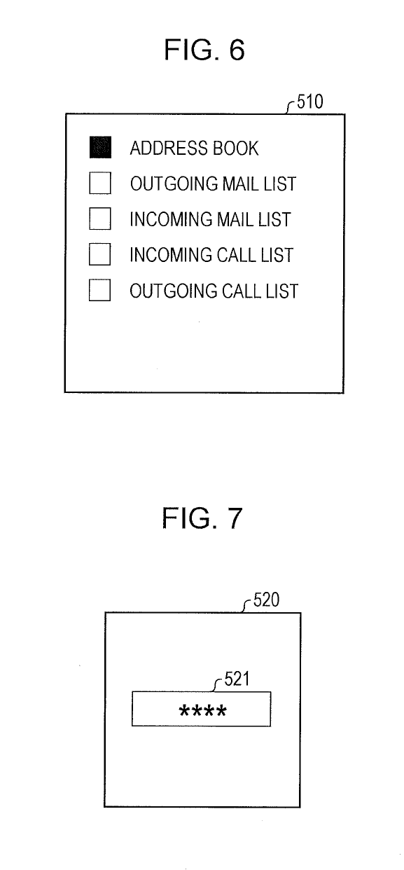

FIG. 6 is a diagram illustrating a display example of a menu screen. A menu screen 510 illustrated in FIG. 6 includes menu items, such as an address book, an outgoing mail list, an incoming mail list, an incoming call list, an outgoing call list, etc. For example, in S101, any one of the menu items is selected. In this regard, the menu screen 510 is also displayed on the operator terminal 20 on the basis of the mechanism described in FIG. 4A and FIG. 4B.

Next, the protected-data management unit 122 determines whether the operation instruction is an operation (or access) on the protected data or not (S102). Whether the operation instruction is an operation on the protected data or not is determined on, for example, whether the data to be operated by the operation instruction is password-protected or not. Accordingly, if the operation instruction is on protected data (Yes in S102), the protected-data management unit 122 displays a password input screen on the display unit 106, and receives input of a password through the password input screen (S103).

FIG. 7 is a diagram illustrating a display example of a password input screen. In FIG. 7, the password input screen 520 includes a password input area 521. In this regard, the password input screen 520 is also displayed on the operator terminal 20 on the basis of the mechanism described in FIGS. 4A and 4B.

If a correct password is inputted through the password input screen 520 (Yes in S103), the protected-data management unit 122 changes an operation state of the current user terminal 10 to a protection mode (S104). Specifically, information indicating a protection mode (hereinafter referred to as a “protection flag”) is recorded, for example, in the memory unit 103. The protection mode indicates an operation state in which protected data is to be operated.

In this regard, the protected data is not limited to be protected by a password. For example, setting information indicating whether protected data or not may be recorded for each data type (an email, a captured image, an address book, bookmarks, an incoming call list, an outgoing call list, etc.) in the auxiliary storage unit 102. In this case, in S102, the protected-data management unit 122 determines whether the operation instruction is on an operation on protected data by referring to the setting information. If the operation instruction is on an operation on protected data, password input has not to be requested, and the current mode is changed to the protection mode.

On the other hand, if the input operation instruction is not on an operation of protected data (No in S102), the current mode is not changed to a protection mode, and the processing proceeds to S105.

In S105, the application unit 123 makes a drawing request of an image in accordance with the operation instruction to the drawing processing unit 124. Next, the drawing processing unit 124 draws (writes) an image in accordance with the drawing instruction from the application unit 123 into the screen data of the frame buffer 131 (S106). As a result, the screen in accordance with the operation instruction is displayed on the user terminal 10. For example, if the display instruction is displaying an address book, an address book screen is displayed.

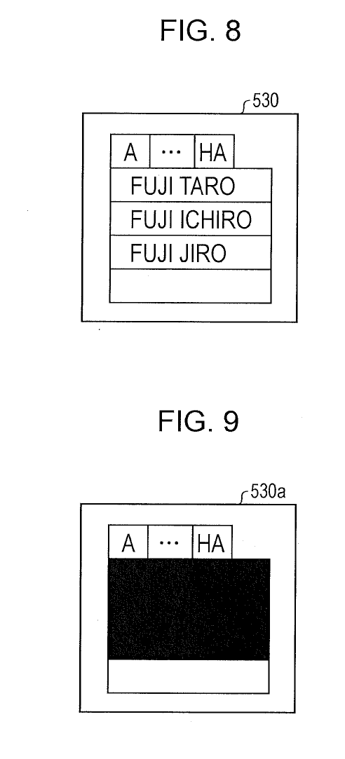

FIG. 8 is a diagram illustrating a display example of an address book screen on a user terminal. On an address book screen 530 in FIG. 8, an example of an entry list in the “Ha” column in the Japanese kana syllabary is illustrated. Individual entry names (Fuji Taro, etc.) are character strings obtained by the protected-data storage unit 132.

Next, the update checking unit 126 performs extraction and mask processing of the difference image between the screen data in the frame buffer 131 at previous checking time and the screen data in the frame buffer 131 at this time (S107). That is to say, the difference image of screen data before and after the drawing by the drawing processing unit 124 is extracted, and the difference image is subject to masking when needed. For example, the characteristic strings indicating the individual entry names of the address book screen 530 is subject to masking. In this regard, the difference image is generated and held in a memory area other than the frame buffer 131. Accordingly, the masking on the difference image does not affect the display contents of the address book screen 530 displayed on the user terminal 10.

In this regard, in FIG. 5, processing in S107 is illustrated to be executed in synchronism with processing in S106, etc. However, the update checking unit 126 checks the frame buffer 131 on a certain cycle asynchronously with the drawing processing by the drawing processing unit 124.

Next, the drawing-command transmission unit 127 transmits a drawing command of the difference image to the operator terminal 20 (S108).

In the operator terminal 20, when the drawing-command receiving unit 23 receives the drawing command (Yes in S201), the drawing processing unit 24 updates the display contents of the screen of the operator terminal 20 in accordance with the drawing command (S202). As a result, the address book screen 520 is displayed on the operator terminal 20.

FIG. 9 is a diagram illustrating a display example of an address book screen on an operator terminal. In an address book screen 530a illustrated in FIG. 9, the individual entry names are masked. Accordingly, the operator is not allowed to refer to the individual entry names. That is to say, leakage of the protected data is restrained.

In this regard, the operation instruction in the processing of S101 in FIG. 5 may be inputted from the operator terminal 20. That is to say, the operation instruction may be an operation instruction indicated by the operation command transmitted to the user terminal 10 in accordance with operation on the shared screen on the operator terminal 20.

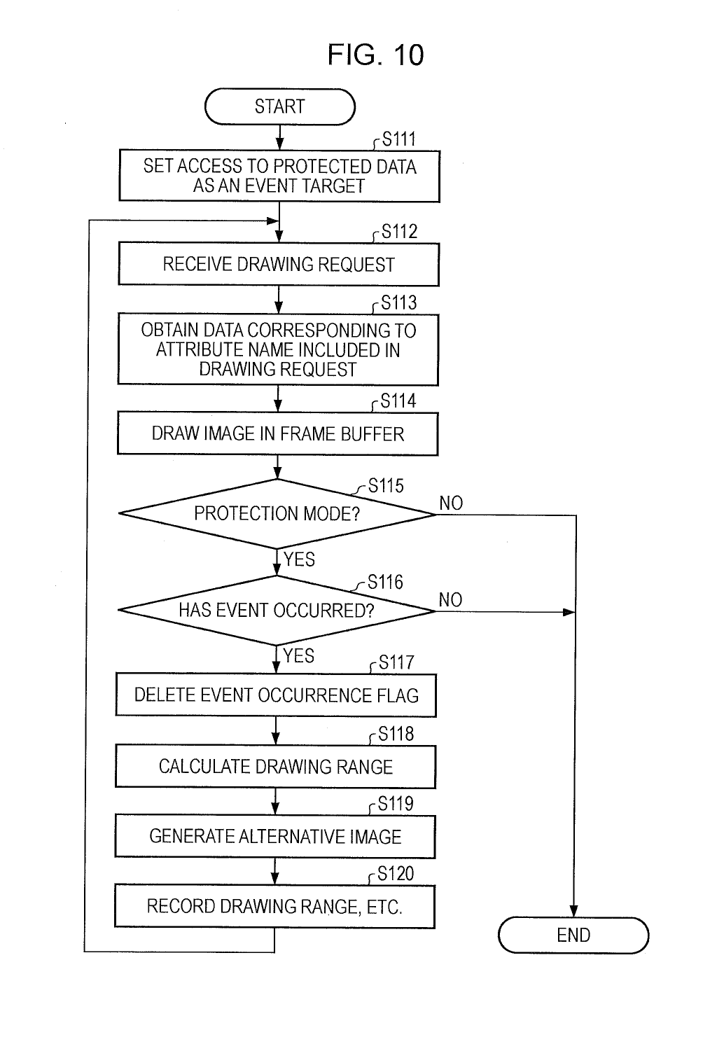

Next, a description will be given of the processing in S106 in FIG. 5. FIG. 10 is a flowchart for explaining an example of a processing procedure of drawing processing.

In S111, the drawing processing unit 124 performs setting for invoking an event at the time of accessing to the protected-data storage unit 132. For example, when an access to the protected-data storage unit 132 occurs, an address of a function to be called (hereinafter referred to as an “event handler”), etc., is set. In this regard, the processing in S111 may not be executed every time the processing in S106 is executed. For example, the processing in S111 ought to be executed at the time of initializing the drawing processing unit 124, etc.

Next, the drawing processing unit 124 receives a drawing request from the application unit 123 (S112). S112 is a step corresponding to S105 in FIG. 5. In this regard, in a drawing request, an attribute name, a display position, etc., are specified. The attribute name indicates identification names of an address book, an incoming call list, an outgoing call list, incoming mails, outgoing mails, etc., or an image, etc., a type and a function of a screen. In this regard, an image is, for example, an image captured by a digital camera included in the user terminal 10, and recorded in the protected-data storage unit 132. However, what format is applied to the interface of the drawing processing unit 124, that is to say, what boundary or division of roles are specified between the application unit 123 and the drawing processing unit 124 is determined in any way. Accordingly, the processing executed by the drawing processing unit 124 in the present embodiment may be performed by, a so-called application, or the processing executed by the application unit 123 in the present embodiment may be performed by a so-called group of drawing functions.

Next, the drawing processing unit 124 obtains data corresponding to an attribute name specified in the drawing request (S113). The data corresponding to an attribute name indicates, for example, an address information list, etc., if the attribute name is an “address book”. Also, if the attribute name is an “incoming call list”, it is the contents of the incoming call list. If a target to be obtained at this time (access target) is the protected data stored in the protected-data storage unit 132, the event handler is invoked. The event handler records, for example, information (hereinafter referred to as an “event occurrence flag”) indicating that an incidence of invocation (that is to say, an occurrence of an access to protected data) in the memory unit 103.

Next, the drawing processing unit 124 draws the image of the obtained protected data at a position specified in the drawing request in the screen data stored in the frame buffer 131 (S114). If the contents of the protected data is a characteristic string, such as an address book, etc., the characteristic string is changed into images (imaged) and is drawn.

Next, the drawing processing unit 124 determines whether the protection mode or not (S115). For example, a determination is made of whether the protection flag is recorded in the memory unit 103 or not. If not in the protection mode (No in S115), the processing in accordance with the drawing request is terminated.

On the other hand, if in the protection mode (Yes in S115), the drawing processing unit 124 checks whether the event occurrence flag is recorded in the memory unit 103 or not (S116). If the event occurrence flag is not recorded (No in S116), the processing in accordance with the drawing request is terminated. This is the case where although in the protection mode, the protected data is not accessed.

On the other hand, if the event occurrence flag is recorded in the memory unit 103 (Yes in S116), the drawing processing unit 124 deletes the event occurrence flag (S117). This is because the event occurrence flag for drawing this time will not be effective for drawing the next time. Next, the drawing processing unit 124 calculates a position and a size of a rectangular area (drawing range) in which the image has been drawn in S114 (S118).

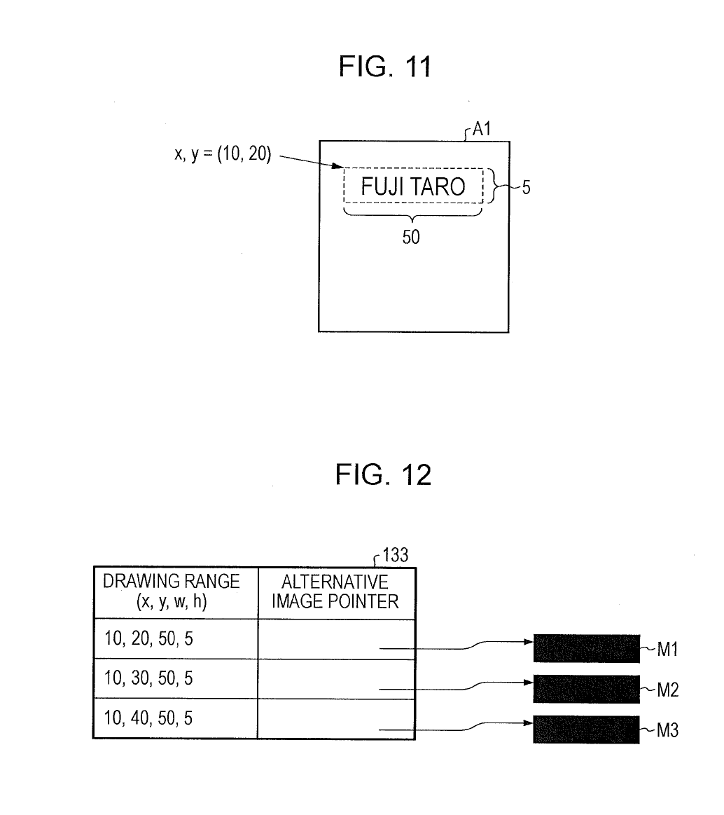

FIG. 11 is a diagram illustrating an example of a drawing range. In FIG. 11, a drawing range Al on a characteristic sting of “Fuji Taro” is illustrated. The drawing range A1 is the rectangular area surrounding the characteristic sting of “Fuji Taro”. An example in which the coordinates of an upper-left vertex of the drawing range A1 are (10, 20), the width is “50”, and the height is “5” is illustrated.

In this manner, the drawing range is a rectangular area surrounding a drawn element (a characteristic string, an image, a figure, etc.). In S118, for example, the coordinates of an upper-left vertex of the drawing range drawing range, the height, and the width are calculated. The coordinates of an upper-left vertex, the height, and the width are, for example, values on the basis of a coordinate system having an upper-left point of the screen of the user terminal 10 as an origin.

Next, the drawing processing unit 124 generates an image having the same size as that of the drawing range, for example, in the memory unit 103 (S119). The image is for masking the drawn contents of the drawing range. Accordingly, the image is not limited to have predetermined contents as long as the image attains that purpose. In the present embodiment, an image whose pixels are all black is generated. In this regard, the image is referred to as an “alternative image” hereinafter.

Next, the drawing processing unit 124 records the position and the size of the drawing range, and a pointer to the alternative image (an address in the memory), etc., into the drawing-range storage unit 133 (S120).

FIG. 12 is a diagram illustrating an example of a configuration of the drawing-range storage unit. As illustrated in FIG. 12, the drawing-range storage unit 133 stores a position, a size, and a pointer to an alternative image, etc., for each drawing range. In FIG. 12, an example is illustrated in which positions and sizes are recorded for three drawing ranges, respectively, and alternative images M1, M2, and M3 are generated for the individual drawing ranges, respectively.

In this regard, in FIG. 10, even in the protection mode, only in the case where the event occurrence flag is recorded, generation of an alternative image and recording in the drawing-range storage unit 133, etc., are performed. As is apparent as described below, this indicates that the difference image is masked only in the case where the event occurrence flag is recorded. This is intended to avoid masking all the drawing elements in the case of the protection mode. For example, on the address book screen 530a in FIG. 9, the names are masked, but a heading part (“A” and “Ha”, etc.) is not masked. This is because when the processing in S112 and after that is executed in response to a drawing request of a characteristic on the heading part, generation of an alternative image and recording in the drawing-range storage unit 133, etc., are not performed, and as a result, the heading part is not targeted for masking. However, in the display example in FIG. 9, it is assumed that the heading part is not data stored in the protected-data storage unit 132. Accordingly, if characteristics in the heading part is stored in the protected-data storage unit 132, generation of an alternative image and recording in the drawing-range storage unit 133, etc., are also performed for the heading part.

In this regard, the masking of the drawing element displayed together with the protected data may be avoided by another method. For example, when the application unit 123 makes a drawing request to the drawing processing unit 124, an argument indicating whether the protected data or not may be passed. In this case, the drawing processing unit 124 ought to perform branching at S116 using the argument.

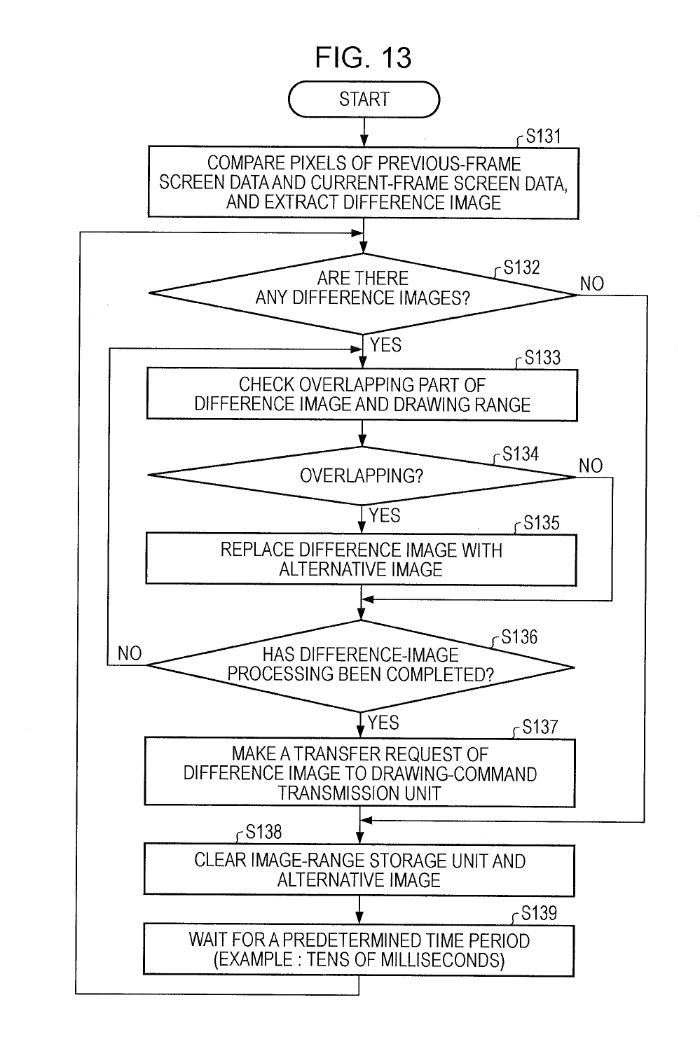

Next, a description will be given of detailed processing of S107 in FIG. 5. FIG. 13 is a flowchart for explaining an example of a processing procedure of extraction and mask processing.

When time has come for checking update of the frame buffer 131, the update checking unit 126 compares the screen data stored in the frame buffer 131 at the time of previous checking and the screen data stored in the frame buffer 131 at this time of this checking, and extracts the difference image (S131). If the difference is separated into a plurality of parts, a plurality of difference images are extracted. In this regard, the difference image is, for example, an image of a minimum rectangular area including the difference pixels.

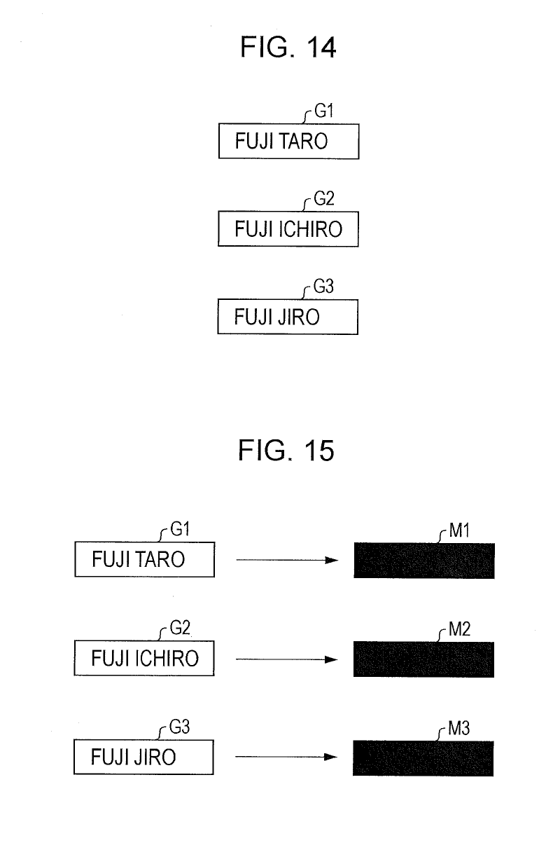

FIG. 14 is a diagram illustrating an example of an extracted difference image. FIG. 14 illustrates an example in which difference images G1, G2, and G3 are extracted in the case where the address book screen 530 is drawn. In this regard, the extracted individual difference images and positions and sizes of the individual difference images are recorded, for example, in the memory unit 103.

Next, the update checking unit 126 determines whether there is a difference image or not (S132). If there is a difference image (Yes in S132), the update checking unit 126 selects that one difference image to be processed. The update checking unit 126 compares a position and a size of the difference image, and the positions and the sizes of the individual difference images recorded in the drawing-range storage unit 133, and determines whether the difference image has an overlapping part with any one of the drawing ranges (S133).

If there is a drawing range having an overlapping part with the difference image (Yes in S134), the update checking unit 126 replaces the difference image with an alternative image for the drawing range having an overlapping part with the difference image (S135). If individual drawing ranges are close to each other, it is thought that there are a plurality of drawing ranges having an overlapping part with the difference image. In such a case, the difference image ought to be replaced with an alternative image corresponding to a drawing range having an overlapping part with a largest area. Normally, the difference image is replaced with an alternative image that substantially overlap the difference image.

In this regard, “replace” indicates here that the difference image is replaced with the alternative image. However, the replacement with the alternative image may be performed by producing the alternative image by the combination of the difference image and the overlapping part.

On the other hand, if there is no drawing range having an overlapping part with the difference image (No in S134), the difference image is not replaced with the alternative image.

The processing from S133 to S135 is performed for all the extracted difference images (S136). As a result, for example, the difference images G1 to G3 illustrated in FIG. 14 are replaced with alternative images corresponding to the drawing ranges having overlapping parts with the individual difference images G1 to G3.

FIG. 15 is a diagram for explaining an example of replacing a difference image with an alternative image. FIG. 15 illustrates an example in which the difference images G1, G2, and G3 are replaced with the alternative images M1, M2, and M3.

In this regard, in the processing of S136 and after that, for a difference image having been replaced with an alternative image, a “difference image” indicates the alternative image.

Next, the update checking unit 126 makes a transfer request of the difference image to the drawing-command transmission unit 127 (S137). The processing of S108 in FIG. 5 is executed in response to the request. Next, the update checking unit 126 deletes the contents of the image-range storage unit and the alternative image (S138). Next, the update checking unit 126 waits for a predetermined time period (for example, tens of milliseconds) (S139), and the processing of S131 and after that is repeated.

As a result of processing described in FIG. 10 and FIG. 13, for example, the address book screen 530 in FIG. 8 is displayed on the operator terminal 20 as illustrated in FIG. 9.

In this regard, in the above, an address book is illustrated as a specific example. When the other protected data, such as incoming mails, outgoing mails, a incoming call list, an outgoing call list, an image, etc., are displayed on the operator terminal 20, masking is performed at least on the protected data. In this regard, the masking is processing applied on an image, and thus even if masking is performed, it is possible to perform remote operation from the operator terminal 20.

As described above, by the present embodiment, it is possible to inhibit protected data from being displayed on a screen sharing destination in a screen sharing state. Accordingly, for example, when a user's terminal is remotely operated by an operator of the help desk, it is possible to inhibit protected data from being displayed accidentally.

On the other hand, an object to be masked is an image to be transferred to a screen sharing destination, and thus there is little possibility that the convenience of the user terminal 10 is deteriorated by the masking.

In this regard, in the present embodiment, an example in which a difference image is transferred for screen sharing has been illustrated. However, the present embodiment can be applied to the case where the entire screen image is periodically transferred from the screen sharing source (user terminal 10) to the screen sharing destination (operator terminal 20). That is to say, in an image of the entire screen transferred to the screen sharing destination, an overlapping part in a position and size of a drawing range stored in the drawing-range storage unit 133 ought to be replaced (masked) by an alternative image corresponding to the drawing range. However, it is possible to improve processing efficiency of the entire screen sharing more in the case of masking a difference image as in the present embodiment.

In this regard, in the present embodiment, the protected-data storage unit 132 is an example of the information storage unit. The drawing processing unit 124 is an example of the drawing unit. The update checking unit 126 is an example of the replacing unit. The drawing-command transmission unit 127 is an example of the transferring unit. The drawing-range storage unit 133 is an example of the range storage unit.

In the above, an embodiment of the present disclosure has been described in detail. However, the present disclosure is not limited to such a specific embodiment, and various variations and changes can be made within the spirit and scope of the present disclosure, which is described in the appended claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A method of sharing a screen, performed by a computer, the method comprising:
drawing on a screen an image on predetermined information stored in an information storage unit and recording, in a range storage unit, range information indicating a range of the image on the screen;
replacing, performed by the computer, the range indicated by the range information stored in the range storage unit with a predetermined image in the image on the screen to be transferred to a sharing destination of the screen; and
transferring the image on the screen having the range replaced with the predetermined image to an apparatus of the sharing destination of the screen.

2. The method of sharing a screen according to claim 1, wherein the replacing extracts a difference image of the screen before and after the drawing, and replaces a difference image related to the range indicated by the range information of the extracted difference image with the predetermined image, and the transferring transfers the difference image or the predetermined image to the sharing destination of the screen.

3. A screen sharing apparatus comprising:
a drawing unit configured to draw on a screen an image on predetermined information stored in an information storage unit and to record, in a range storage unit, range information indicating a range of the image on the screen;
a replacing unit configured to replace the range indicated by the range information stored in the range storage unit with a predetermined image in the image on the screen to be transferred to a sharing destination of the screen; and
a transferring unit configured to transfer the image on the screen having the range replaced with the predetermined image to an apparatus of the sharing destination of the screen.

4. The screen sharing apparatus according to claim 3, wherein the replacing unit extracts a difference image of the screen before and after the drawing, and replaces a difference image related to the range indicated by the range information of the extracted difference image with the predetermined image, and the transferring unit transfers the difference image or the predetermined image to the sharing destination of the screen.

5. A non-transitory, computer readable storage medium storing a program for causing a computer to perform processing, the processing comprising:
drawing on a screen an image on predetermined information stored in an information storage unit and recording, in a range storage unit, range information indicating a range of the image on the screen;
replacing the range indicated by the range information stored in the range storage unit with a predetermined image in the image on the screen to be transferred to a sharing destination of the screen; and
transferring the image on the screen having the range replaced with the predetermined image to an apparatus of the sharing destination of the screen.

6. The non-transitory, computer readable storage medium according to claim 5, wherein the replacing extracts a difference image of the screen before and after the drawing, and replaces a difference image related to the range indicated by the range information of the extracted difference image with the predetermined image, and the transferring transfers the difference image or the predetermined image to the sharing destination of the screen.
